(19) United States
(12) Patent Application Publication
(10) Pub. No.: US 2007/0006981 A1
(43) Pub. Date: Jan. 11, 2007

(54) WINDOW BLIND WITH HOLLOW SLATS

(76) Inventor: Ker-Min Lin, Chiayi City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/469,704

(22) Filed: Sep. 1, 2006

Related U.S. Application Data
(63) Continuation-in-part of application No. 10/847,265, filed on May 16, 2004.

(51) Int. Cl. E06B 9/26

(52) U.S. Cl. 160/166.1

(57) ABSTRACT

A window blind includes an upper beam and a plurality of slats mounted to and below the upper beam. Each slat is formed of extruded plastic and includes a plurality of channels that provide an insulating and noise depression effect. Each slat includes first and second parallel edges and first and second ends extending between the first and second edges. The slats are arranged in a parallel relation and movable between a fully extended state and a fully collapsed state. The channels of each slat extend longitudinally through a whole length of the slat. Each slat includes first and second outer walls forming two opposite flat, parallel surfaces. The first and second edges extend between the first and second outer walls. The channels are located between the first and second outer walls.

### CROSS REFERENCE TO RELATED APPLICATION

This is a continuation-in-part application of U.S. patent application Ser. No. 10/847,265 filed May 16, 2004.

### BACKGROUND OF THE INVENTION

1. Field of the Invention

The present invention relates to a window blind and, more particularly, to a window blind with horizontal or vertical slats.

2. Description of the Related Art

It is well known to provide a window with insulation for keeping heat and/or noise outside. The conventional approach is to replace windows with multi-pane glass, to add additional storm windows, etc. on the outside of windows, etc, which are expensive, or to use plastic sheeting to the outside which is inexpensive but is deficient in aesthetics, cannot be opened to allow airflow, and need to be taken down in summer.

It is also conventional to include shutters on the outside of windows. Although one of the primary purposes of shutters is for security, shutters including hollow louvers providing heat and noise insulation have been suggested. However, due to their complicated assemblies for mounting and adjusting the louvers permanently to the outside of the window, shutters are not desirable or would not be considered except for limited circumstances typically when security is a concern.

Blinds are a conventional window treatment to control light or viewing passage. Blinds utilize slats 3 made of solid sheet plates shown in FIG. 6 often of metal or light weight material due their light weight and cost. However, due to their inefficiency in isolating heat and noise due to the use of conventional slat structures, use of blinds as a possible solution to isolate heat and/or noise has not been considered.

Thus, there is a continuing need for methods of providing a window with insulation against heat and/or noise transfer which overcomes the deficiencies of prior approaches. In particular, what is desired is a manner to provide a window with insulation for heat and/or noise which is mounted inside of the window, which does not detract in aesthetics, which can be opened to allow airflow, which need not be taken down when insulation is not required, which is not expensive to the consumer, and which can be easily added to existing windows, even by homeowners themselves.

### SUMMARY OF THE INVENTION

A window blind in accordance with the present invention comprises an upper beam adapted to be mounted to an inside of a frame of a window and a plurality of slats mounted to and below the upper beam. Each slat is formed of extruded plastic and includes an inside formed with a plurality of channels. Each slat includes first and second parallel edges and first and second ends extending between the first and second edges. The slats are arranged in a parallel relation and movable between a fully collapsed state and a fully extended state. The channels provide an insulating and noise depression effect. The channels of each slat extend longitudinally through a whole length of the slat between the first and second ends. Each slat includes first and second outer walls forming two opposite flat, parallel surfaces. The first and second edges extend between the first and second outer walls. The channels are located between the first and second outer walls.

When the slats are in the fully collapsed state, the slats overlap one another and have a minimal span. Two adjacent outer walls respectively of two adjacent slats abut against each other. The slats have a first dimension equal to a whole length between the first and second ends of each slat, a second dimension equal to a width between the first and second edges of each slat, and a third dimension equal to a sum of thicknesses of all of the plurality of slats.

The slats in the fully extended state are movable between an open state and a closed state. The slats in the fully extended, open state are in spaced, parallel relation.

The slats in the fully extended, closed state have a maximal span. Further, the slats in the fully extended, closed state have a first dimension equal to a whole length between the first and second ends of each slat, a second dimension substantially the same as a thickness between the opposite flat, parallel surfaces of each slat, and a third dimension substantially the same as a sum of the widths of all of the plurality of slats.

Preferably, the thickness between the opposite flat, parallel surfaces of each slat is about 1 mm to 5 mm.

Preferably, each channel of each slat is triangular or rectangular in section perpendicular to the first and second edges.

Preferably, each slat includes an intermediate wall spaced from, intermediate and parallel to the first and second outer walls. The first, second, and intermediate walls are planar. The channels in each slat includes a first layer between the first outer wall and the intermediate wall and a second layer between the second outer wall and the intermediate wall, with the first and second layers laminating each other.

In an example, the window blind further includes first and second support cords extending in a parallel, spaced relation perpendicular to the upper beam. The first and second support cords support the plurality of slats in the parallel relation and move the plurality of slats between the fully collapsed and fully extended states. The first and second edges of the slats extend parallel to the upper beam. Preferably, an operative cord is connected to the support cords for moving the slats between the fully collapsed state and the fully extended state.

In another example, the first and second edges of the plurality of slats extend perpendicular to the upper beam. A slide is mounted to an upper end of each slat. An operative cord is connected to each slide. The slides are moved by operating the operative cord for moving the slats between the fully collapsed state and the fully extended state.

Preferably, the window blind further comprises means for adjusting a tilt angle of the plurality of slats.

Preferably, when the plurality of slats are in the fully extended, closed state, the plurality of slats provide a sound level reduction of approximately 33 decibels for a high frequency sound source.

Preferably, when the plurality of slats are in the fully extended, closed state, and slats provide a sound level reduction of approximately 12 decibels for a low frequency sound source.

Preferably, the plurality of slats have an R value of about 0.268 hr·ft²·° F./Btu and thermal conductivity of about 0.0386 Btu/hr·ft·° F.

An objective of the present invention is to provide a slat structure for a vertical or horizontal window blind.

Another objective of the present invention is to provide a window blind with a plurality of slats that can be adjustable between a fully collapsed state and a fully extended state, wherein the material of each slat is greatly reduced by provision of the channels in the slat, thereby decreasing costs of fabrication of the slat.

A further objective of the present invention is to provide a window blind with a plurality of slats that can be adjustable between a fully collapsed state and a fully extended state, wherein the total weight of the slats is greatly reduced by provision of the channels of the slats, thereby facilitating packaging, transportation and assembly of the slats.

Still another objective of the present invention is to provide a window blind with a plurality of slats that can be adjustable between a fully collapsed state and a fully extended state, wherein the total weight of the slats is reduced, so that the burden applied on the support cords or slides of the window blind is reduced, thereby enhancing the lifetime of the window blind.

Yet another objective of the present invention is to provide a window blind with a plurality of slats that can be adjustable between a fully collapsed state and a fully extended state, wherein the channels of the slats efficiently isolate the source of heat and noise, thereby providing an insulating and noise depression effect.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of an example of a slat structure of a window blind in accordance with the present invention.

FIG. 2 is a partially cut-away perspective view of another example of the slat structure of the window blind in accordance with the present invention.

FIG. 3 is a side view of a further example of the slat structure of the window blind in accordance with the present invention.

FIG. 4 is a perspective view of an embodiment of the window blind in the form of a Venetian blind in a fully extended state.

FIG. 5 is a perspective view of another embodiment of the window blind in the form of a vertical blind in a fully extended state.

FIG. 6 is a perspective view of a conventional slat structure in accordance with the prior art.

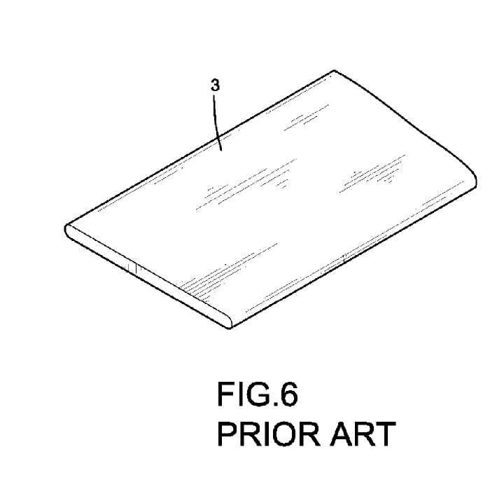

FIG. 7 is a perspective view of the Venetian blind in FIG. 4 in a fully collapsed state.

FIG. 8 is a perspective view of the vertical blind in FIG. 5 in a fully collapsed state.

FIG. 9 is a perspective view of the Venetian blind in FIG. 4 in a closed state.

FIG. 10 is a perspective view of the vertical blind in FIG. 5 in a closed state.

### DETAILED DESCRIPTION OF THE PREFERRED EMBODIMENT

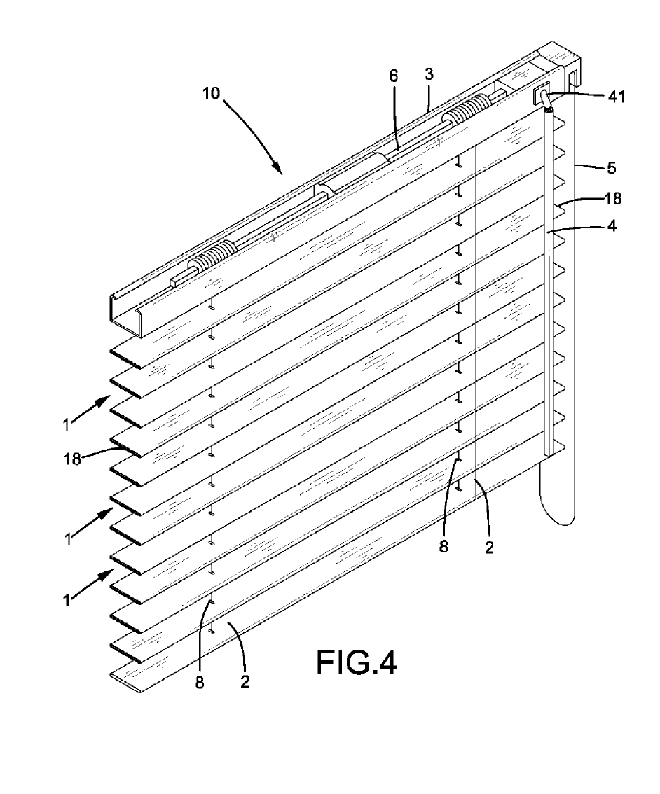

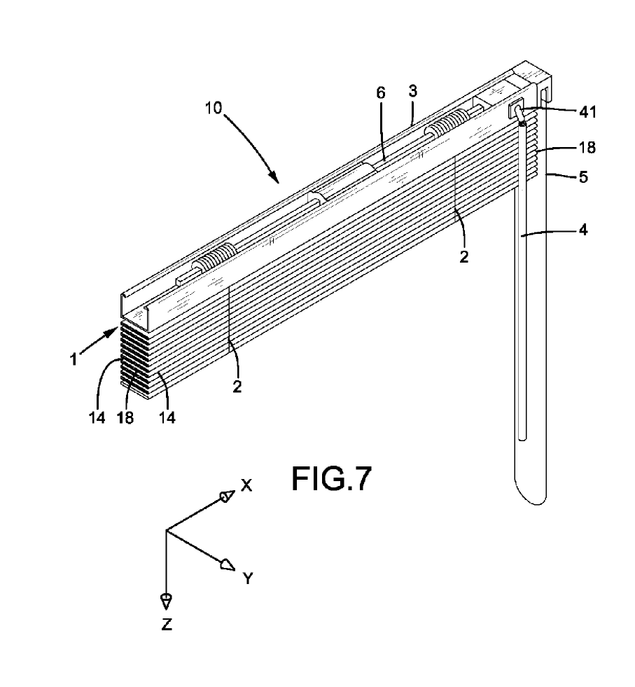

FIG. 4 illustrates an embodiment of a window blind 10 in accordance with the present invention. In this example, the window blind 10 is a Venetian blind including a plurality of horizontally extending slats 1 when mounted to a window. More specifically, the Venetian blind 10 comprises an upper beam 3 mounted to an inside of a frame (not shown) of a window (not shown) and a plurality of horizontally extending slats 1 mounted to and below the upper beam 3. Two support cords 8 are extended through the slats 1 in a parallel spaced relation perpendicular to the upper beam 3 for supporting the slats 1 in a parallel relation. An operative cord 5 is operatively connected to the support cords 8 for controlling collapse of the slats 1. Namely, the slats 1 can be moved between a fully extended state shown in FIG. 4 (the slats 1 are in spaced, parallel relation and have a maximal span) and a fully collapsed shown in FIG. 7 (the slats 1 overlap one another and have a minimal span for a larger view) upon operation of the operative cord 5. Of course, an intermediate position of the slats 1 can be obtained, which is conventional.

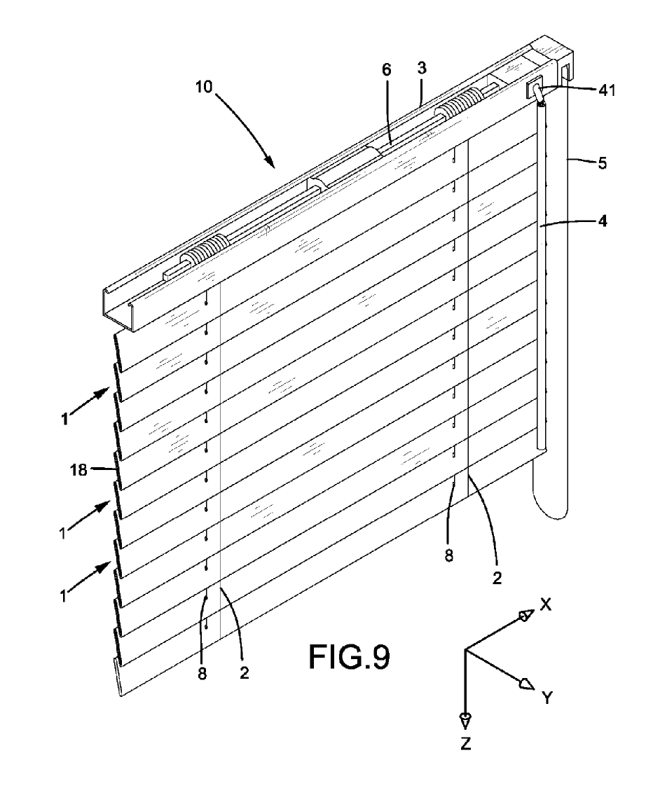

The Venetian blind 10 further includes a tilt angle adjusting device. In this example, the tilt angle adjusting device includes a tilt rod 6 rotatably mounted in the upper beam 3, an operative rod 4, an actuating member 41, and two tilt cords 2 connected to the tilt rod 6, which are conventional. When the operative rod 4 is lifted to a position aligned and engaged with the actuating member 41, the operative rod 4 can be turned to pivot the tilt rod 6 and move the tilt cords 2, thereby changing the tilt angle of the slats 1. After adjustment, the operative rod 4 is disengaged from the actuating member 41 to avoid inadvertent change in the tilt angle of the slats 1. The slats 1 of the Venetian blind 10 shown in FIG. 4 are in an open state. The stats 1 can be moved to a closed state shown in FIG. 9 by operating the tilt rod 6, as mentioned above.

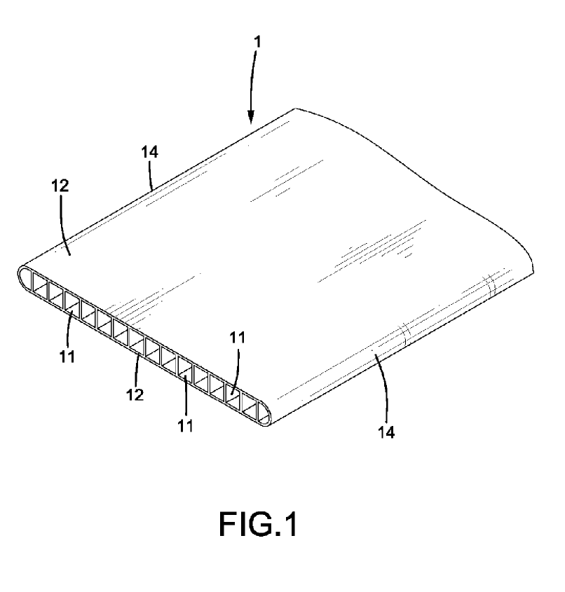

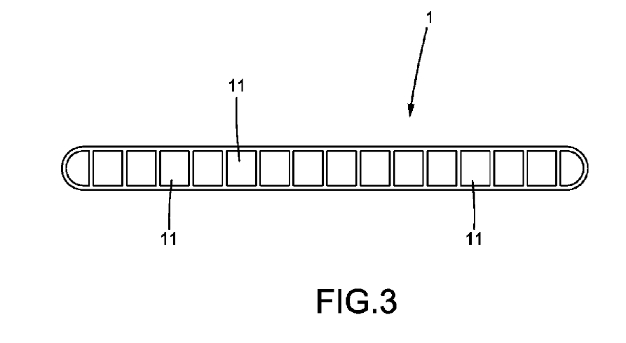

In an example shown in FIG. 1, each slat 1 includes first and second parallel edges 14 and first and second ends 18 extending between the first and second edges 14. Further, each slat 1 includes first and second outer walls 12 providing two opposite flat, parallel surfaces, with the edges 14 being arcuate and extending between the first and second outer walls 12. Further, each slat 1 includes a plurality of channels 11 extending longitudinally between the first and second outer walls 12 and through the whole length of the slat 1 between the first and second ends 18. Each channel 11 is triangular in section perpendicular to the first and second edges 14. In another example shown in FIG. 3, each channel 11 is rectangular in section perpendicular to the first and second edges 14. The slat 1 is preferably a planar plate formed by a plastic extruding process. Namely, the slat 1 is an extruded plastic slat. Each slat 1 has a thickness of about 1 mm to 5 mm between the opposite flat, parallel surfaces.

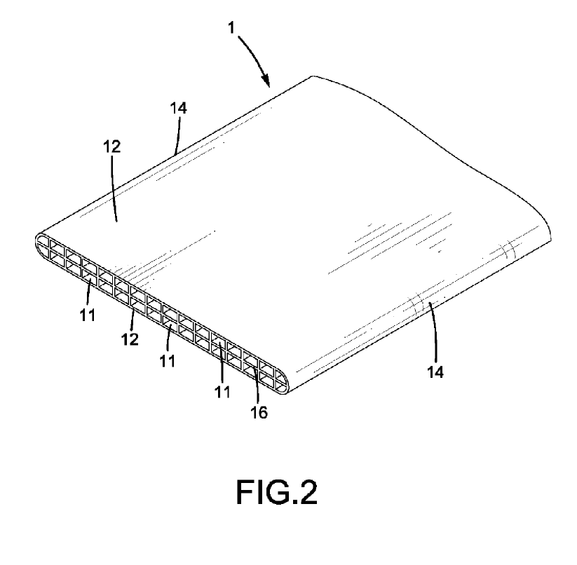

In a further example shown in FIG. 2, each slat 1 further includes an intermediate wall 16 spaced from, intermediate and parallel to the first and second outer walls 12. The first, second, and intermediate walls 12 and 16 are planar. The channels 11 in each slat 1 include a first layer between the first outer wall 12 and the intermediate wall 16 and a second layer between the second outer wall 12 and the intermediate wall 16. Preferably, the first and second layers laminate each other. In this example, each channel 11 extends longitudinally through the whole length of the slat 1 and is rectangular in section perpendicular to the first and second edges 14.

When the slats 1 of the Venetian blind 10 are in the fully collapsed state shown in FIG. 7, the slats 1 overlap one another and have a minimal span. Two adjacent outer walls 12 (see FIG. 1) respectively of two adjacent slats 1 abut against each other. The slats 1 have a first dimension (in the X-direction in FIG. 7) equal to a whole length between the first and second ends 18 of each slat 1, a second dimension (in the Y-direction in FIG. 7) equal to a width between the first and second edges 14 of each slats 1, and a third dimension (in the Z-direction in FIG. 7) equal to a sum of thicknesses of all of the plurality of slats 1.

When the slats 1 of the Venetian blind 10 are in the fully extended, open state, the plurality of slats are in a spaced, parallel relation, as shown in FIG. 4. When the slats 1 of the Venetian blind 10 are in the fully extended, closed state shown in FIG. 9, the slats 1 have a maximal span. More specifically, when the slats 1 are in the fully extended, closed state, the slats 1 have a first dimension (in the X-direction of FIG. 9) equal to a whole length between the first and second ends 18 of each slats 1, a second dimension (in the Y-direction of FIG. 9) substantially the same as a thickness between the opposite flat, parallel surfaces of each slat 1, and a third dimension (in the Z-direction of FIG. 9) substantially the same as a sum of the widths of all of the plurality of slats 1.

Accordingly, the material of the slat 1 is greatly reduced by provision of the channels 11 of the slat 1, thereby decreasing costs of fabrication of the slat structure. In addition, the total weight of the slat structure is greatly reduced by provision of the channels 11 of the slat 1, thereby facilitating packaging, transportation and assembly of the slat structure. Further, the total weight of the slat structure is reduced, so that the burden applied on the support cords 8 of the Venetian blind 10 is reduced, thereby enhancing the lifetime of the Venetian blind 10. Further, the channels 11 of the slat structure efficiently isolate the source of heat and noise, thereby providing an insulating and noise depression effect, which will be described later.

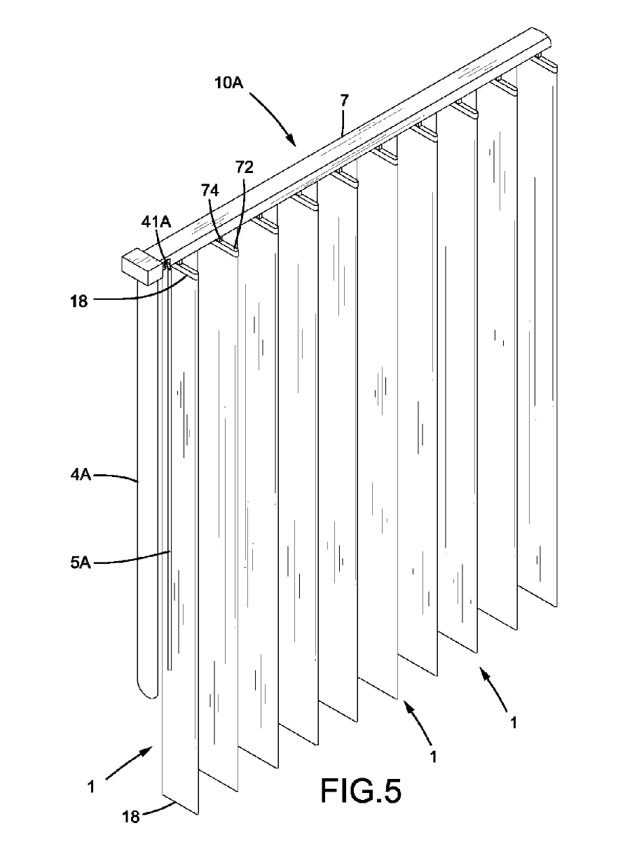

FIG. 5 shows another embodiment of the window blind in accordance with the present invention. In this example, the window blind 10A is in the form of a vertical blind including a plurality of vertically extending slats 1 when mounted to a window. More specifically, the vertical blind 10A comprises an upper beam 7 mounted to an inside of a frame (not shown) of a window (not shown) and a plurality of vertically extending slats 1 mounted to and below the upper beam 7. It is noted that the first and second edges 12 of the slats 1 extend perpendicular to the upper beam 7 in the vertical blind 10A shown in FIG. 5 whereas the first and second edges 12 of the slats 1 extend parallel to the upper beam 3 in the Venetian blind 10 shown in FIG. 4.

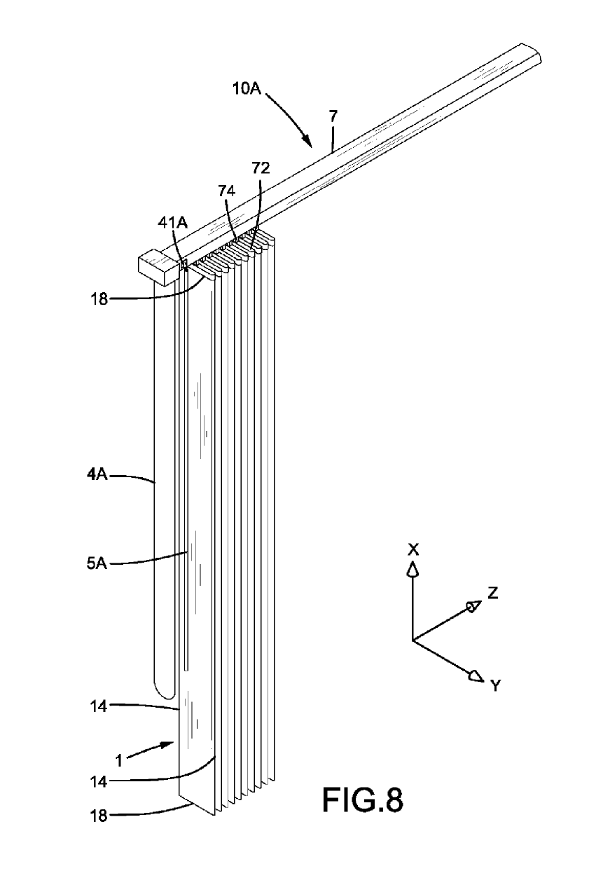

A slide 74 is coupled via an engaging member 72 to an upper one of the ends 18 of each slat 1. An operative cord 5A is provided for controlling collapse of the plurality of slats 1. When the operative cord 5A is pulled in a direction, the slides 74 move along a rail (not shown) in the upper beam 7 to thereby collapse or extend the plurality of slats 1. Namely, the plurality of slats 1 can be moved between a fully extended state shown in FIG. 5 (the slats 1 are in spaced, parallel relation and have a maximal span) and a fully collapsed state shown in FIG. 8 (the slats 1 overlap one another and have a minimal span for a larger view) upon operation of the operative cord 5A. Of course, an intermediate position of the plurality of slats 1 can be obtained, which is conventional.

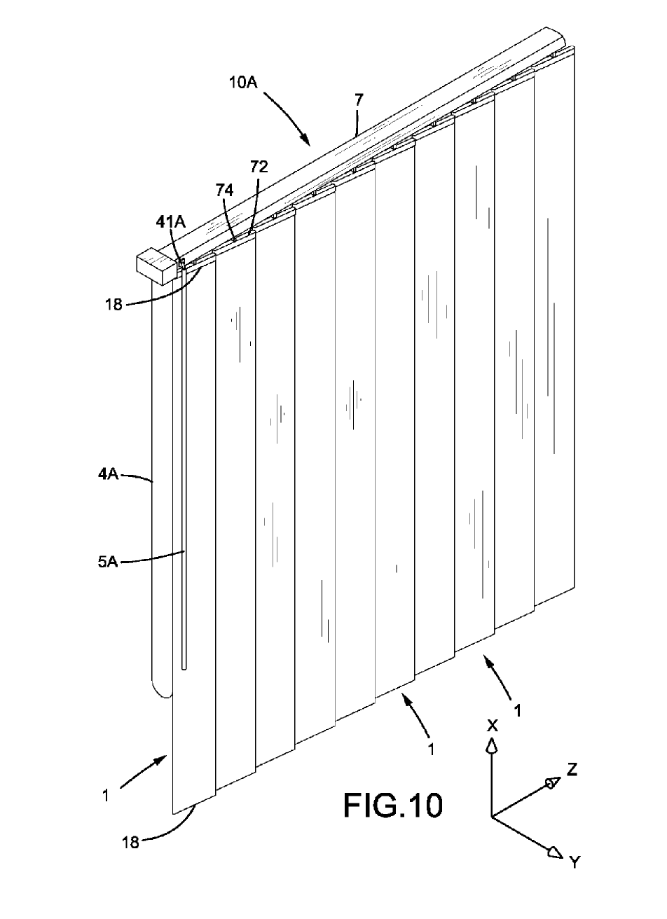

The vertical blind 10A further includes a tilt angle adjusting device. In this example, the tilt angle adjusting device includes an operative rod 4A and an actuating member 41A, which are conventional. When the operative rod 4A is lifted to a position aligned with and engaged with the actuating member 41A, the operative rod 4A can be turned to change the tilt angle of the slats 1. After adjustment, the operative rod 4A is disengaged from the actuating member 41A to avoid inadvertent change in the tilt angle of the slats 1. The plurality of slats 1 of the vertical blind 10A shown in FIG. 5 are in an open state. The plurality of slats 1 can be moved to a closed state shown in FIG. 10 by operating the tilt rod 6A, as mentioned above.

When the plurality of slats 1 of the vertical blind 10A are in the fully collapsed state shown in FIG. 8, the slats 1 overlap one another and have a minimal span. Two adjacent outer walls 12 (see FIG. 1) respectively of two adjacent slats 1 abut against each other. The plurality of slats 1 have a first dimension (in the X-direction in FIG. 8) equal to a whole length between the first and second ends 18 of each slat 1, a second dimension (in the Y-direction in FIG. 8) equal to a width between the first and second edges 14 of each slat 1, and a third dimension (in the Z-direction in FIG. 8) equal to a sum of thicknesses of all of the plurality of slats 1.

When the slats 1 of the vertical blind 10A are in the fully extended, open state, the plurality of slats 1 are in spaced, parallel relation, as shown in FIG. 5. When the plurality of slats 1 of the vertical blind 10A are in the fully extended, closed state shown in FIG. 10, the plurality of slats 1 have a maximal span. More specifically, when the plurality of slats 1 are in the fully extended, closed state, the plurality of slats 1 have a first dimension (in the X-direction of FIG. 10) equal to a whole length between the first and second ends 18 of each slat 1, a second dimension (in the Y-direction of FIG. 10) substantially the same as a thickness between the opposite flat, parallel surfaces of each slat 1, and a third dimension (in the Z-direction of FIG. 10) substantially the same as a sum of the widths of all of the plurality of slats 1.

The slats shown in FIGS. 1 through 3 can be used with the vertical blind 10A for reducing the overall weight while providing the required heat/noise depressing effect. More specifically, the material of the slat 1 is greatly reduced by provision of the channels 11 of the slat 1, thereby decreasing costs of fabrication of the slat structure. In addition, the total weight of the slat structure is greatly reduced by provision of the channels 11 of the slat 1, thereby facilitating packaging, transportation and assembly of the slat structure. Further, the total weight of the slat structure is reduced, so that the burden applied on the slides 74 of the vertical blind 10A is reduced, thereby enhancing the lifetime of the vertical blind 10A. Further, the channels 11 of the slat structure efficiently isolate the source of heat and noise, thereby providing an insulating and noise depression effect, as described below.

Tests have been carried out to find out the insulating depression effect of the plurality of slats 1 in the closed states. Heat Meter Method (ASTM C-158) was used to measure the R value (surface to surface) and thermal conductivity of the slats (2″ wide and 0.124″ thick) in accordance with the present invention, foam wood blind slats (2″ wide and 0.108″ thick), and composite wood blind slats (2″ wide and 0.126″ thick). The R values of the slat 1 in accordance with the present invention, the foam wood blind slat, and the composite wood blind slat are 0.268 hr·ft²·° F./Btu, 0.204 hr·ft²·° F./Btu, and 0.206 hr·ft²·° F./Btu, respectively. The thermal conductivity of the slat 1 in accordance with the present invention, the foam wood blind slat, and the composite wood blind slat are 0.0386 Btu/hr·ft·° F., 0.0442 Btu/hr·ft·° F., and 0.0522 Btu/hr·ft·° F., respectively.

Tests have also been carried out to find out the noise depression effect of the slats 1 in accordance with the present invention in the closed states. It was found that the slats 1 in accordance with the present invention provide a sound level reduction of approximately 33 decibels for a high frequency (2900 Hertz signal) sound source and of approximately 12 decibels for a low frequency (800 Hertz signal) sound source.

As apparent from the foregoing, the present invention provides a window with insulation for heat and/or noise which is mounted inside of the window, which does not detract in aesthetics, which can be open to allow airflow, which need not be taken down when insulation is not required, which is not expensive to the consumer, and which can be easily added to existing windows, even by homeowners themselves.

Although the invention has been explained in relation to its preferred embodiments as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A window blind comprising:
an upper beam adapted to be mounted to an inside of a frame of a window; and
a plurality of slats mounted to and below the upper beam, with each slat of the plurality of slats formed of extruded plastic and each said slat including an inside formed with a plurality of channels, with each said slat including first and second parallel edges and first and second ends extending between the first and second edges, with the plurality of slats arranged in a parallel relation and movable between a fully collapsed state and a fully extended state, with the plurality of channels providing an insulating and noise depression effect, with the plurality of channels of each said slat extending longitudinally through a whole length of the slat between the first and second ends, with each said slat including first and second outer walls forming two opposite flat, parallel surfaces, with the first and second edges extending between the first and second outer walls, and with said plurality of channels located between the first and second outer walls;
wherein when the plurality of slats are in the fully collapsed state, the plurality of slats overlap one another and have a minimal span, two adjacent said outer walls respectively of two adjacent said slats abut against each other, and the plurality of slats have a first dimension equal to a whole length between the first and second ends of each of the plurality of slats, a second dimension equal to a width between the first and second edges of each of the plurality of slats, and a third dimension equal to a sum of thicknesses between the opposite flat, parallel surfaces of all of the plurality of the slats; and
wherein the plurality of slats in the fully extended state are movable between an open state and a closed state;
wherein the plurality of slats in the fully extended, open state are in spaced, parallel relation; and
wherein the plurality of slats in the fully extended, closed state have a maximal span, and the plurality of slats in the fully extended, closed state have a first dimension equal to a whole length between the first and second ends of each slat of the plurality of slats, a second dimension substantially the same as the thickness of each slat of the plurality of slats, and a third dimension substantially the same as a sum of the widths of all of the plurality of slats.

2. The window blind as claimed in claim 1 wherein the thickness between the opposite flat, parallel surfaces of each said slat is about 1 mm to 5 mm.

3. The window blind as claimed in claim 1 wherein each of the plurality of channels of each said slat is triangular in section perpendicular to the first and second edges.

4. The window blind as claimed in claim 1 wherein each of the plurality of channels of each said slat is rectangular in section perpendicular to the first and second edges.

5. The window blind as claimed in claim 1 wherein each said slat includes an intermediate wall spaced from, intermediate and parallel to the first and second outer walls, with the first, second, and intermediate walls being planar, with the channels in each said slat including a first layer between the first outer wall and the intermediate wall and a second layer between the second outer wall and the intermediate wall, with the first and second layers laminating each other.

6. The window blind as claimed in claim 1 further comprising first and second support cords extending in a parallel, spaced relation perpendicular to the upper beam, with the first and second support cords supporting the plurality of slats in the parallel relation and moving the plurality of slats between the fully collapsed and fully extended states, with the first and second edges of the plurality of slats extending parallel to the upper beam.

7. The window blind as claimed in claim 6 further comprising an operative cord connected to the first and second support cords for moving the plurality of slats between the fully collapsed state and the fully extended state.

8. The window blind as claimed in claim 1 wherein the first and second edges of the plurality of slats extend perpendicular to the upper beam.

9. The window blind as claimed in claim 8 further comprising a slide mounted to the first end of each said slat, and an operative cord connected to each said slide, said slides being moved by operating the operative cord for moving the slats between the fully collapsed state and the fully extended state.

10. The window blind as claimed in claim 1 further comprising means for adjusting a tilt angle of each slat of the plurality of slats.

11. The window blind as claimed in claim 1 wherein when the plurality of slats are in the fully extended, closed state, the plurality of slats provide a sound level reduction of approximately 33 decibels for a high frequency sound source.

12. The window blind as claimed in claim 11 wherein the plurality of slats have an R value of about 0.268 hr·ft²·° F./Btu and thermal conductivity of about 0.0386 Btu/hr·ft·° F.

13. The window blind as claimed in claim 1 wherein when the plurality of slats are in the fully extended, closed state, and the plurality of slats provide a sound level reduction of approximately 12 decibels for a low frequency sound source.

14. The window blind as claimed in claim 13 wherein the plurality of slats have an R value of about 0.268 hr·ft²·° F./Btu and thermal conductivity of about 0.0386 Btu/hr·ft·° F.

15. The window blind as claimed in claim 1 wherein the plurality of slats have an R value of about 0.268 hr·ft²·° F./Btu and thermal conductivity of about 0.0386 Btu/hr·ft·° F.
